(19) United States
(12) Patent Application Publication
(10) Pub. No.: US 2002/0085646 A1
(43) Pub. Date: Jul. 4, 2002

(54) Apparatus and method for detecting bit disparity within a data stream

(76) Inventors: Matthew D. Brown, Kinburn (CA); James Moser, Ottawa (CA); Warren Sande, Ottawa (CA); Lucian A. Agapie, San Diego, CA (US)

Correspondence Address: Gowling Lafleur Henderson LLP, Suite 2600, 160 Elgin Street, Otawa, ON, K1P 1C3, CA

(21) Appl. No.: 10/005,333

(22) Filed: Dec. 7, 2001

(30) Foreign Application Priority Data
Dec. 8, 2000 (CA) 2,327,908

(51) Int. Cl. H04L 25/34; H04L 25/49

(52) U.S. Cl. 375/292

(57) ABSTRACT

The present invention relates to an optical communications system performance monitoring technique which provides for detecting bit disparity within a data stream. The average power value for a data stream is ascertained by passing the data stream through a low pass filter. The data stream's average power value is then compared with a bit stream baseline power value for a one bit stream and a zero bit stream, the resulting deviation comprising a bit disparity value. An embodiment of this invention would incorporate the use of threshold alarms set for unacceptably high levels of bit disparity. The triggering of these threshold alarms could initiate the transmission of automated customer warnings such as a notification that performance cannot be guaranteed due to high bit disparity on the signal.

### FIELD OF THE INVENTION

The present invention relates to the monitoring of signal quality within an optical communications network, and more specifically to an apparatus and method for detecting bit disparity within a data stream.

### BACKGROUND OF THE INVENTION

Signal quality degradation has become a significant problem within today's optical communications networks. Signal quality degradation causes a host of difficulties such as decreased bandwidth, lack of reliability and loss of signal.

One of the largest contributors to signal quality degradation is the manifestation of what is known as bit disparity. Bit disparity is a condition whereby the ratio of ones and zeros within a data stream deviates from a 1:1 ratio. Under optimum conditions it is expected that the number of ones in a signal will be equal to the number of zeros in that signal or, in other words, the density of ones or zeros in the signal will be 50%.

High bit disparity can cause numerous problems within an optical communications system such as having difficulty controlling the laser light source, causing the laser output power to be sufficiently different from the expected value such that an alarm is triggered, producing bit errors within a coupling capacitor and creating undesired amplitude modulations of wavelengths within optical amplifiers.

The inherent problems of bit disparity within optical communications networks is typically tolerated and manifests itself as bit errors within the system. The performance of modem optical communications networks would be better served by monitoring data streams to detect bit disparity quickly and reliably so that a warning may be provided and compensation made for the presence of bit disparity, once detected.

For the foregoing reasons, there is a need for a quick and reliable method of detecting bit disparity within a data stream of an optical communications network.

### SUMMARY OF THE INVENTION

The present invention is directed to an apparatus and method for detecting bit disparity within a data stream which comprises low pass filtering a data stream to determine the data stream's average power value. A bit stream baseline power value is then determined for the data stream. The average power value is then compared to the baseline power value, with the resulting deviation comprising a bit disparity value.

In aspects of the invention a number of features can be added to the system so that once a bit disparity value has been ascertained for a data stream, the added features can be initiated. These added features can include a real-time automated adjustment in the control of a laser and the setting of a threshold alarm to trigger upon detection of a high measurement of the bit disparity value whereby an automated customer warning such as a notification that performance cannot be guaranteed due to high bit disparity levels on the signal may be transmitted upon the triggering of the threshold alarm.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of an embodiment of the method for detecting bit disparity within a data stream;

FIG. 2 is an overview of an embodiment of the method for detecting bit disparity within a data stream further comprising triggering a threshold alarm;

FIG. 3 is an overview of an embodiment of the method for detecting bit disparity within a data stream further comprising adjusting the control of a laser;

FIG. 4 is an overview of an embodiment of the method for detecting bit disparity within a data stream further comprising converting the bit disparity value into a digital representation;

FIG. 5 is an overview of an embodiment of the apparatus for detecting bit disparity within a data stream;

FIG. 6 is an overview of an embodiment of the apparatus for detecting bit disparity within a data stream further comprising a threshold alarm;

FIG. 7 is an overview of an embodiment of the apparatus for detecting bit disparity within a data stream further comprising a laser control; and

FIG. 8 is an overview of an embodiment of the apparatus for detecting bit disparity within a data stream further comprising an analog/digital converter.

### DETAILED DESCRIPTION OF THE PRESENTLY PREFERRED EMBODIMENT

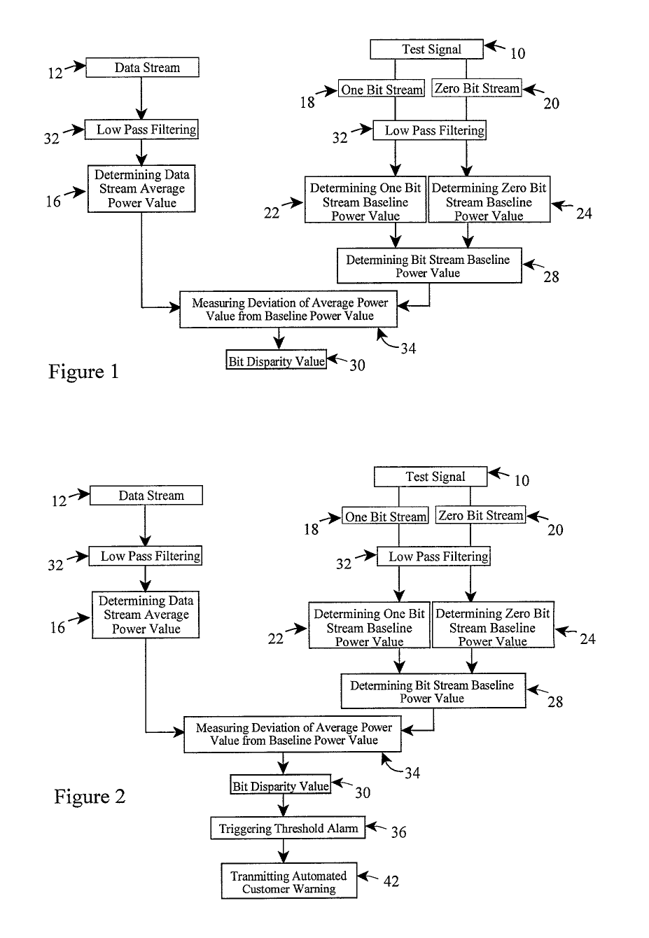

As shown in FIG. 1, an embodiment of the method for detecting bit disparity within a data stream comprises low pass filtering 32 the data stream 12 to determine a data stream average power value 16 and low pass filtering a one bit stream 18 and a zero bit stream 20 from a test signal 10 to determine a bit stream baseline power value 28 for the test signal 10.

The median value of the one bit stream baseline power value 22 and the zero bit stream baseline power value 24 is then ascertained so as to determine the bit stream baseline power value 28 of the test signal 10 since, under optimum conditions, it is expected that the density of ones or zeros in a given signal will be 50%, the bit stream baseline power value 28 would be the median value of the one bit stream baseline power value 22 and the zero bit stream baseline power value 24. The average power value 16 is then compared to the baseline power value 28, with the resulting measured deviation comprising a bit disparity value 30.

As shown in FIG. 2, the invention may further comprise triggering a threshold alarm 36 upon detection of a high measurement of the bit disparity value 30 and transmitting an automated customer warning 42 upon the triggering of the threshold alarm 36.

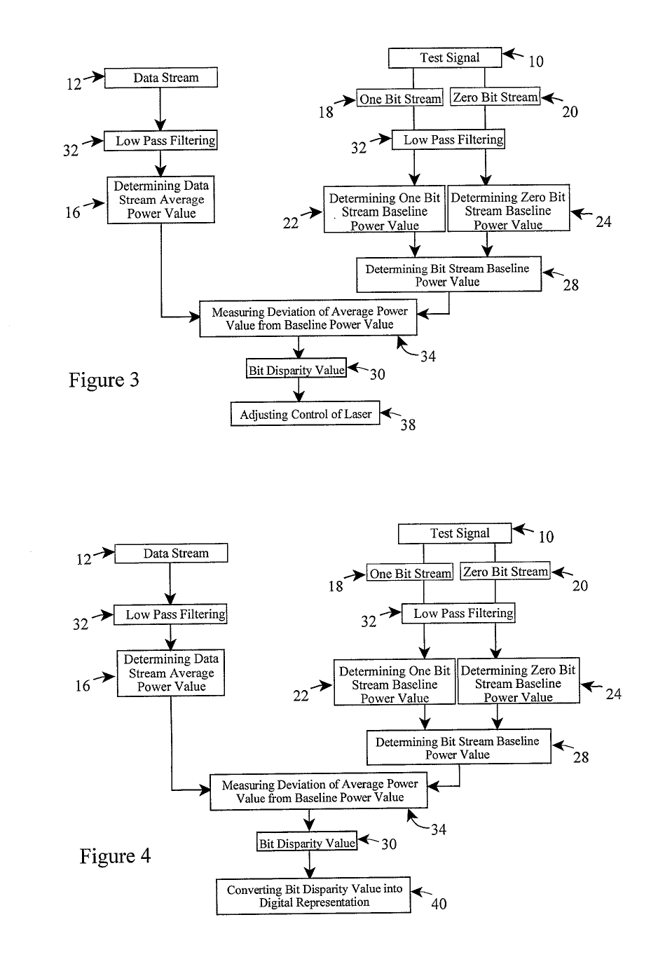

As shown in FIG. 3, the invention may further comprise adjusting the control of a laser 38 upon detection of a high measurement of the bit disparity value 30.

As shown in FIG. 4, the invention may further comprise converting the bit disparity value 30 into a digital representation 40.

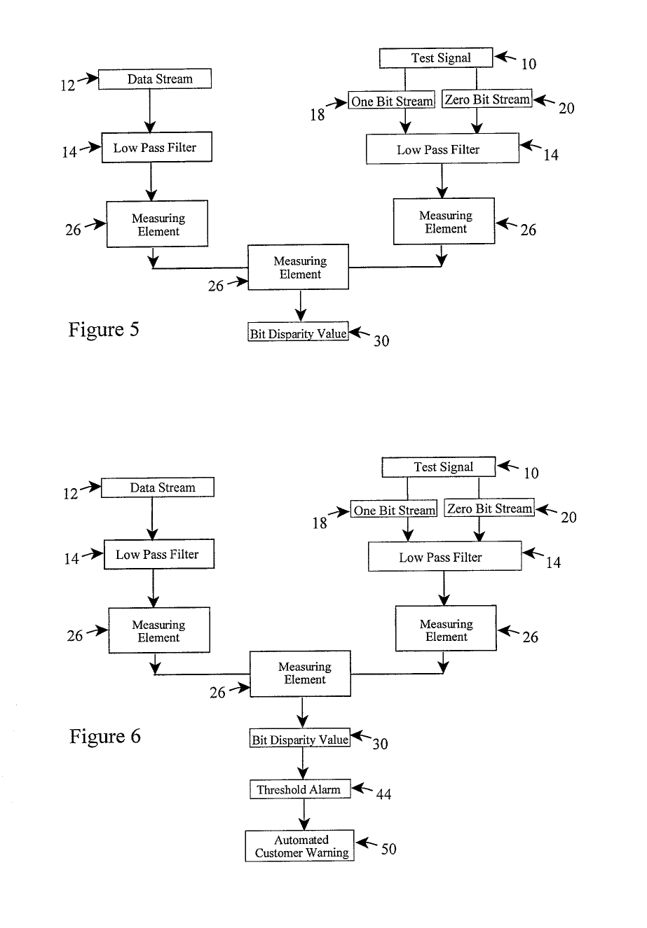

As shown in FIG. 5, an embodiment of the apparatus for detecting bit disparity within a data stream comprises a low pass filter 14 for determining an average power value for a data stream 16 and for determining a one bit stream baseline power value 22 and a zero bit stream baseline power value 24 from a test signal 10, a measuring element 26 for ascertaining the median value of the one bit stream baseline power value 22 and the zero bit stream power value 24 to determine the bit stream baseline power value 28 of the test signal 10 and for measuring the deviation of the average power value 16 from the baseline power value 28 to determine a bit disparity value 30.

As shown in FIG. 6, the invention may further comprise a threshold alarm 44 set to trigger upon detection of a high measurement of the bit disparity value 30 whereby an automated customer warning 50 may be transmitted upon the triggering of the threshold alarm 44.

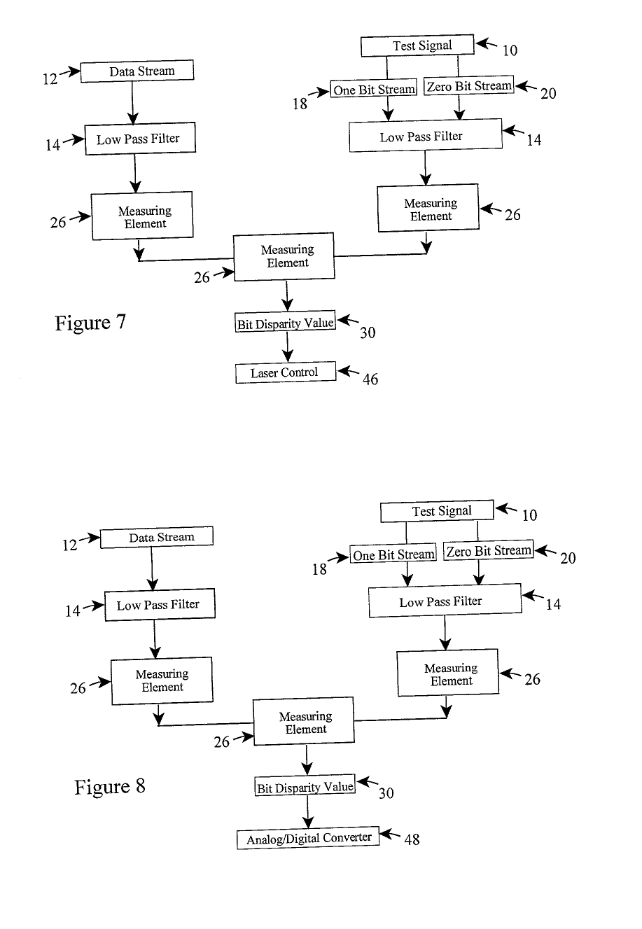

As shown in FIG. 7, the invention may further comprise a laser control 46 for automatically adjusting a laser in real-time upon detection of a high measurement of the bit disparity value 30.

As shown in FIG. 8, the invention may further comprise an analog/digital converter 48 to convert the bit disparity value 30 into a digital representation.

In some system implementations such as those involving protocols 100BFX, FDDI, and D1 video, there is a higher propensity to deviate from the 1:1 ratio. Therefore, threshold settings should be adjusted accordingly.

Although the present invention has been described in considerable detail with reference to certain preferred versions thereof, otherversions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method of detecting bit disparity within a data stream comprising the steps of:
(i) low pass filtering of the data stream to determine a data stream average power value;
(ii) determining a bit stream baseline power value from a test signal; and
(iii) measuring the deviation of the average power value from the baseline power value to determine a bit disparity value.

2. The method according to claim 1, wherein the step of determining a bit stream baseline power value for the data stream comprises the steps of:
(i) determining a one bit stream baseline power value and a zero bit stream baseline power value from the test signal; and
(ii) ascertaining the median value of the one bit stream baseline power value and the zero bit stream baseline power value to determine the bit stream baseline power value of the test signal.

3. The method according to claim 1, further comprising the steps of:
(i) triggering a threshold alarm upon detection of a high measurement of the bit disparity value; and
(ii) transmitting an automated customer warning upon the triggering of the threshold alarm.

4. The method according to claim 1, further comprising the step of adjusting the control of a laser upon detection of a high measurement of the bit disparity value.

5. The method according to claim 1, further comprising the step of converting the bit disparity value into a digital representation.

6. An apparatus for detecting bit disparity within a data stream, the apparatus comprising:
a low pass filter for determining an average power value for a data stream and for determining a one bit stream baseline power value and a zero bit stream baseline power value from a test signal; and
a measuring element for ascertaining the median value of the one bit stream baseline power value and the zero bit stream baseline power value so as to determine a bit stream baseline power value of the test signal and for measuring the deviation of the average power value from the baseline power value to determine a bit disparity value.

7. The apparatus according to claim 6, further comprising a threshold alarm set to trigger upon detection of a high measurement of the bit disparity value whereby an automated customer warning may be transmitted upon the triggering of the threshold alarm.

8. The apparatus according to claim 6, further comprising a laser control for automatically adjusting the laser in real-time upon detection of a high measurement of the bit disparity value.

9. The apparatus according to claim 6, further comprising an analog/digital converter to convert the bit disparity value into a digital representation.

10. An apparatus for detecting bit disparity within a data stream, the apparatus comprising:
means for determining a data stream's average power value;
means for determining a bit stream baseline power value; and
means for measuring the deviation of the average power value from the bit stream baseline power value to determine a bit disparity value.

11. The apparatus according to claim 10, wherein the means for determining a bit stream baseline power value comprises:
means for determining a one bit stream baseline power value and a zero bit stream baseline power value from a test signal;
means for ascertaining the median value of the one bit stream baseline power value and the zero bit stream baseline power value to determine the bit stream baseline power value of the test signal.

12. The apparatus according to claim 10, further comprising means whereby an automated customer warning may be transmitted upon detection of a high measurement of the bit disparity value.

13. The apparatus according to claim 10, further comprising means for automatically adjusting the laser in real-time upon detection of a high measurement of the bit disparity value.

14. The apparatus according to claim 10, further comprising a means to convert the bit disparity value into a digital representation.
